(19) United States
(12) Patent Application Publication
(10) Pub. No.: US 2012/0192122 A1
(43) Pub. Date: Jul. 26, 2012

(54) METHOD AND SYSTEM FOR DISPLAYING IMAGES ON A VIDEO SCREEN

(76) Inventor: Philippe Leroy, Paris (FR)

(21) Appl. No.: 13/260,646

(22) PCT Filed: Mar. 27, 2009
(86) PCT No.: PCT/FR2009/000355

§ 371 Date: Jan. 30, 2012

(51) Int. Cl. G06F 3/14

(52) U.S. Cl. 715/867

(57) ABSTRACT

A system and method for displaying video images on a video screen of equipment including a function for displaying video images on said screen and an internal clock. The system includes a folder containing a plurality of video images; and an application for calculating a correspondence rule associating the time supplied by said internal clock with a video image of said folder, and for displaying on said screen successive video images of the folder starting from the video image that is associated by said correspondence rule with the time at which the video image display function was activated.

### FIELD OF THE INVENTION

The present invention relates to a method of displaying images on a video screen of equipment that includes a function for displaying video images on said screen. The invention also relates to a system for displaying video images on a video screen of such equipment, and to equipment including said system.

The invention is applicable more particularly to:

manufacturers of mobile telephones, pocket computers, and other video players. In this context, the invention represents a sales pitch with the end user on selling such equipment, and after sales it constitutes a way of keeping customers loyal;

mobile telephone operators and Internet sites for downloading applications and video contents for mobile telephones, pocket computers, and other video players. For such operators, the invention provides an additional source of revenue by downloading the video image display function and video images for display, e.g. when the equipment is on standby or when the user is taking action thereon, immediately on the user touching the equipment; and

the users of mobile telephones, pocket computers, or other video players for whom the invention constitutes a source of relaxation and means for personalizing the equipment.

### BACKGROUND OF THE INVENTION

The term “function for displaying video images” covers not only a “screen standby” function during which images are displayed automatically on the equipment being put on standby, after being inactive for a certain length of time, and also a “screen wallpaper” function where images are displayed as a result as soon as the user starts to act on the equipment.

At present, when a function for displaying video images on equipment is activated, the video content that is displayed on the screen is identical on each occasion the equipment is put on standby, regardless of whether the image is still or animated.

This results in the display having a repetitive aspect that the user soon finds wearying.

### OBJECT AND SUMMARY OF THE INVENTION

In order to remedy this drawback, the invention provides a method of displaying images on a video screen of equipment including a function for displaying video images on said screen and an internal clock, wherein the method comprises the steps consisting in:

creating in said equipment a folder of a plurality of video images;

establishing and storing in said equipment a correspondence rule that associates the time supplied by said internal clock with a video image of said folder; and

after at least one activation of the video image display function of the equipment, displaying successive video images from the folder on said screen starting from the video image that is associated by said correspondence rule with the time the video image display function was activated.

Thus, it can be understood that when the equipment goes into standby mode at some given time, for example, the method of the invention causes it to search for the video image that is associated with that time in application of the previously established correspondence rule. This initial video image is then displayed on the screen of the equipment, followed by the images that follow it in the video image folder, which folder may be downloaded and stored in a memory of the equipment.

In a first implementation, the video images of the folder are numbered sequentially, and said correspondence rule associates a time supplied by the internal clock with a video image number.

In this implementation, the video images of the folder are all numbered in sequence, i.e. in a determined order. When the video image display function is activated, the first video image to be displayed is the image having the number that is associated by the correspondence rule with the time at which the display function was activated. Thereafter the video images are displayed in their numerical order starting from the initial image.

The set of video images in the folder may have a duration of 24 hours (h), in the sense that in the absence of any interruption of the display, each image is repeated once every 24 h. When the images are displayed on the screen with uniform periodicity of n images per minute, the total number of video images in the folder is then equal to 1440×n. The value of the number n is a function of the memory capacity of the equipment under consideration. For example, in order to display one video image every 10 seconds, it is necessary for the memory to store a folder containing 8640 images.

The display of video images may be interrupted by the equipment leaving its “standby” mode, e.g. because the equipment enters an active mode or because it is switched off by its user. Nevertheless, another possibility for stopping the sequence of images consists, in accordance with the invention, in the display of video images in succession being limited to a given duration, of the order of a few seconds, e.g. about ten.

In a second implementation, the video images are grouped into a plurality of subsets of given duration that are numbered in sequence, and said correspondence rule associates a time supplied by the internal clock with a video image subset number. This subset number is defined as the number given to the first image of the subset by the correspondence rule.

In this second implementation, only the image subsets are numbered in sequence rather than all of the individual images, as in the first implementation described above. When the video image display function is activated, the first video image that is displayed is the first image of the image subset having its number associated by the correspondence rule with the time at which the equipment was put on standby. Thereafter, the video images of the subset as determined in this way are displayed in succession.

As above, the display may be interrupted on a change in the operating mode of equipment or because the display of successive video images in accordance with the invention is limited to the duration of said subset of video images. In other words, the display stops on the last video image of the subset selected by the correspondence rule. The duration of the display of a subset may be of the order of a few seconds, e.g. ten. For 24 subsets having a duration of 10 seconds (s) with a display frequency of p images per second, the total number of video images in the folder is 240×p. Once more, the number p depends on the memory capacity of the equipment.

In practice, the invention provides for said correspondence rule to associate a time range of the time supplied by the internal clock of the equipment with a video image of the folder. The times supplied by the internal clock of the equipment are thus grouped into ranges, with the times in a given range being associated by the correspondence rule with the same initial video image number or with the same image subset, depending on the implementation in question.

The correspondence rule may be uniform in the sense that the time ranges all have the same duration, e.g. 24 ranges of one hour each, or it may be non-uniform, with time ranges that vary depending on the time of day. Thus, in order to avoid always reproducing the same initial image, and thus the same sequence of images, at times during which the equipment is heavily used, it is possible to reduce the durations of time ranges, whereas as night, for example, when the equipment is little used, it is advantageous to define time ranges of longer durations.

Another way of obtaining greater flexibility of display on activation of the image display function consists, according to the invention, in said video image that is associated by said correspondence rule with the time supplied by the internal clock of the equipment being a random function of said time supplied by the internal clock. For example, it is possible to add a random integer number to the number of the initial image or of the subset as established by the correspondence rule.

The invention also provides a system for displaying video images on a video screen of equipment including a function for displaying video images on said screen and an internal clock, wherein the system comprises, in the equipment:

a folder containing a plurality of video images; and

an application for calculating a correspondence rule associating the time supplied by said internal clock with a video image of said folder, and for displaying on said screen successive video images of the folder starting from the video image that is associated by said correspondence rule with the time at which the video image display function was activated.

The invention also provides equipment including an image display system of the invention.

The invention also provides a computer program including instructions that, when the program is executed by a processor of the equipment, are suitable for causing a correspondence rule to be established that associates the time supplied by a clock of the equipment with a video image stored in a folder of the equipment.

Preferably, the computer program also includes instructions suitable for causing a screen of the equipment to display successive video images of the folder starting from the video image that is associated by the correspondence rule with the time at which a video image display function is activated.

The invention also provides a recording medium having a computer program of the invention stored thereon and the invention also provides making a program of the invention available for downloading.

The recording medium of such a program may for example be constituted by data storage means of the equipment or by data storage means of a server associated with a mobile telephone operator or with an Internet site from which the program can be downloaded.

### BRIEF DESCRIPTION OF THE DRAWINGS

The following description with reference to the accompanying drawings, given as non-limiting examples, makes it easy to understand what the invention consists in and how it can be reduced to practice.

FIG. 1 is a diagram of a system in accordance with the invention.

FIG. 2a is a diagram showing the structure of a first embodiment of the image folder of the FIG. 1 system.

FIG. 2b is a diagram giving the structure of a second embodiment of the image folder of the FIG. 1 system.

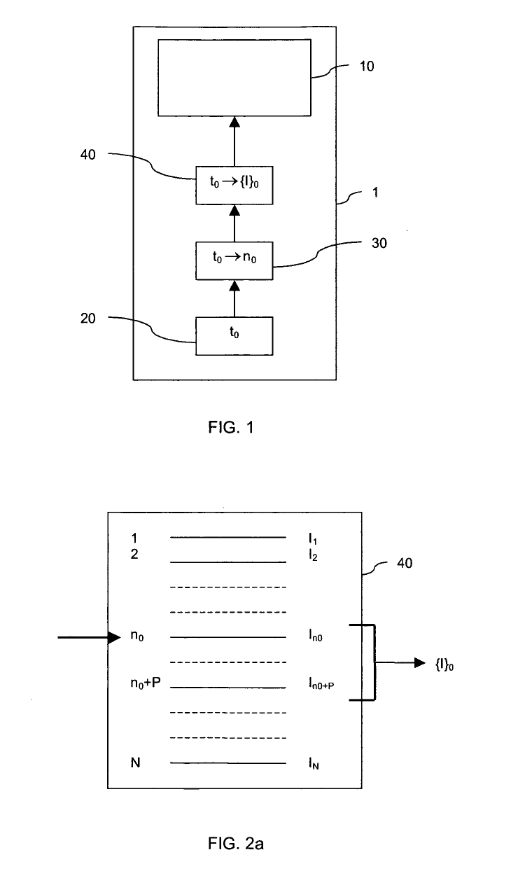

In FIG. 1, there can be seen a system for displaying images on a video screen 10 of a piece of equipment 1 such as a mobile telephone, a pocket computer, or any other video player. To this end, a function for displaying video images on said screen 10, a “screen standby” or “screen wallpaper” function serves in conventional manner to display on the screen 10 video images that are stored in a folder 40 whenever the video image display function of the equipment 1 is activated.

The content of this folder may be selected beforehand and may optionally be downloaded by the user.

The FIG. 1 system also includes an internal clock 20 and an application 30 for establishing a correspondence rule associating a time t supplied by the internal clock 20 with a video image I of the folder 40. This application 30 and the folder 40 are stored in data storage means of the equipment, said means forming a recording medium for the application 30 and the folder 40.

Like the folder 40, the application 30 may be downloaded from a mobile telephone operator or the Internet site of an applications supplier. The server associated with the mobile telephone operator or the Internet site then includes storage means for storing the applications 30 and the folder 40 and forms a recording medium of the invention.

If the image display function is activated at a time t₀ as a result of pressing on a key, of opening a slide-out keyboard, or of any other operation or event, the correspondence rule pre-established in the application 30 supplies a number n₀ for an initial video image, written Iₙ₀, thereby defining a sequence {I}₀ of successive video images I in the folder 40 for displaying on the screen 10, starting from the initial image Iₙ₀.

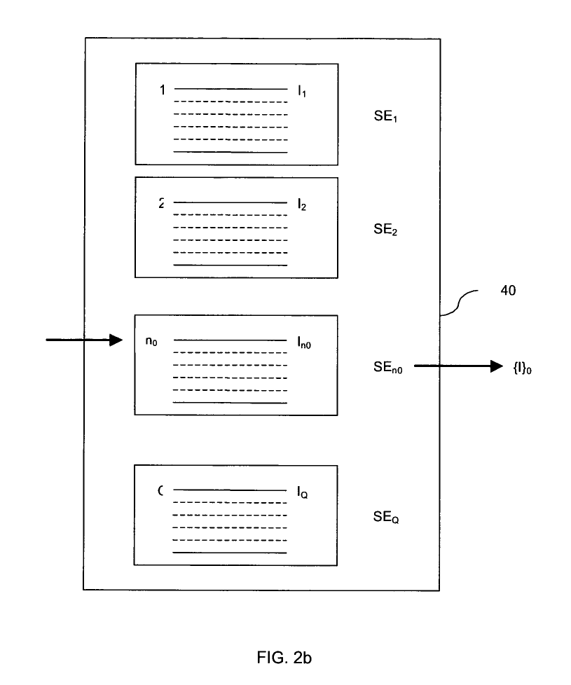

FIG. 2a shows an embodiment in which the folder 40 contains N video images I₁, I₂, . . . , I_{N}, all of which are numbered in sequence 1, 2, . . . , N.

The sequence {I}₀ for displaying on the screen at the time t₀ at which the video image display function of the equipment 1 is activated is constituted by the image Iₙ₀ of number n₀ that is the number defined by the correspondence rule of the application 30, and also by the following successive images up to the last image Iₙ₀₊ₚ of number n_{0+P}. Interrupting the display after image I_{n0+P} may result in the display function itself being interrupted or in a stop after a predetermined display duration that, in the example described, is equal to P×Δt, where Δt is the periodicity with which the images are displayed, e.g. about ten seconds.

For a total duration of 24 h, the number N of images in the folder 40 is equal to 24/Δt, where At is expressed in hours. Δt is selected in such a manner that the total number N of images is compatible with the memory capacity of the equipment 1.

The duration of 24 h may be subdivided into N time ranges, e.g. 24 ranges of one hour each, with the correspondence rule then associating a time given by the internal clock 20 with a time range, and then associating a time range with an image number.

As mentioned above, the time ranges need not necessarily be of uniform durations, in order to provide greater flexibility of display at times when the equipment 1 is heavily used.

It is also possible to obtain better display flexibility by adding a random number r to the number n₀ as supplied directly by the correspondence rule, and then calculating a new number

n′₀=n+r modulo N

associated with a new initial image of number n′₀, and thus a new sequence of images.

FIG. 2b shows another structure for the folder 40 comprising Q subsets SE₁, SE₂, . . . , SE_{Q}, each containing the same number or a different number of video images. Each subset carries a number that may be associated with the number of the initial image of the subset.

If the correspondence rule associates the time range of the time t₀ at which the image display function is activated with a number n₀, then the sequence of images {I}₀ to be displayed on the screen 10 is constituted by the subset SEₙ₀ that begins with the image carrying the number n₀.

Similarly, in like manner, the time ranges need not necessarily be of equal duration, and a random number r may be added modulo Q to the number n₀ that results from applying the correspondence rule.

The duration of the display is limited either by the display function being interrupted, or automatically at the end of the duration of the subset SEₙ₀ as selected by the correspondence rule.

By way of example, the number Q is 24, corresponding to 24 time ranges each of identical one-hour duration. The display duration of a subset may be about ten seconds. Once more, the total number of video images in the folder 40 is a function of the memory capacity of the equipment 1.

Finally, it should be specified that the term “video image” as used herein should be understood broadly, i.e. possibly including not only an image, but also sound.

1. A method of displaying images on a video screen of equipment including a function for displaying video images on said screen and an internal clock, the method comprising:
creating in said equipment a folder of a plurality of video images;
establishing and storing in said equipment a correspondence rule that associates the time supplied by said internal clock with a video image, each time range that might be supplied by the clock being associated with a video image of said folder; and
after at least one activation of the video image display function of the equipment, displaying successive video images from the folder on said screen starting from the video image that is associated by said correspondence rule with the the video image display function was activated.

2. A method according to claim 1, wherein the video images of the folder are numbered sequentially, and said correspondence rule associates a time supplied by the internal clock with a video image number.

3. A method according to claim 2, wherein the display of video images in succession is limited to a given duration.

4. A method according to claim 1, wherein the video images are grouped into a plurality of subsets of given duration that are numbered in sequence, and said correspondence rule associates a time supplied by the internal clock with a video image subset number.

5. A method according to claim 4, wherein the display of video images in succession is limited to the duration of said video image subset.

6. A method according to claim 1, wherein said video image associated by said correspondence rule with the time supplied by the internal clock of the equipment is a random function of said time supplied by the internal clock.

7. A method according to claim 1, wherein said correspondence rule associates a time range of the time supplied by the internal clock of the equipment with a video image of the folder.

8. A system for displaying video images on a video screen of equipment including a function for displaying video images on said screen and an internal clock, the system comprising:
a folder containing a plurality of video images; and
an application for calculating a correspondence rule associating the time supplied by said internal clock with a video image of said folder such that each time range that might be supplied by the clock is associated with a video image of said folder, and for displaying on said screen successive video images of the folder starting from the video image that is associated by said correspondence rule with the time at which the video image display function was activated.

9. Equipment including an image display system according to claim 8.

10. A computer program including instructions that, when the program is executed by a processor of a piece of equipment, are suitable for causing a correspondence rule to be established that associates the time supplied by a clock of the equipment with a video image stored in a folder of the equipment.

11. A computer program according to claim 10, further including instructions suitable for displaying on a screen of the equipment successive video images of the folder starting from the video image associated by the correspondence rule with a time at which a video image display function was activated.

12. A recording medium having stored thereon a computer program according to claim 10.

13. Making a program according to claim 10 available for downloading.
